(19) United States
(12) Patent Application Publication
(10) Pub. No.: US 2022/0258203 A1
(43) Pub. Date: Aug. 18, 2022

(54) COATING METHOD AND SYSTEM TO CREATE PATTERNED COATING LAYERS

(71) Applicant: 3M INNOVATIVE PROPERTIES COMPANY, St. Paul, MN (US)

(72) Inventors: Cameron E. Derry, London (CA); Ranjith Divigalpitiya, London (CA)

(21) Appl. No.: 17/597,546

(22) PCT Filed: Jun. 30, 2020
(86) PCT No.: PCT/IB2020/056176

§ 371 Date: Jan. 11, 2022

Related U.S. Application Data
(60) Provisional application No. 62/875,050, filed on Jul. 17, 2019.

(51) Int. Cl. B05D 5/00; B05D 1/30; B05D 3/12; B05D 1/28; C09D 5/03; C09D 5/24

(52) U.S. Cl. CPC B05D 5/00; B05D 1/30; B05D 3/12; C09D 5/24; C09D 5/032; C09D 5/033; B05D 1/28

(57) ABSTRACT

A method of coating a substrate with a particulate coating composition is disclosed that creates a coated substrate having a controlled, nonuniform surface property profile that varies along at least one primary dimension. The substrate is positioned on a textured template. An effective amount of the particulate coating composition is buffed onto a surface of the substrate with the at least one orbital applicator moving in a plane parallel to surface in a plurality of directions relative to a point on the surface in an orbital manner while at least one process variable is changed during the coating of the substrate. Process variable that can be varied during coating include application time, application pressure, coating temperature, the contour of the textured template, orbital speed, web speed, and the particulate coating composition.

### BACKGROUND OF THE INVENTION

### Field of the Invention

The present invention is directed to a method of coating a substrate to produce a coated article having a surface characterized by a nonuniform surface property profile.

### Background

In general, conventional coating method for applying thin coated layers on a substrate focus on providing a coated article having as uniform and defect free coated surface as possible, such that the surface properties of the coated substrate are as uniform as possible. A multitude of thin coating techniques have been disclosed in the prior art, including sputter coating, physical vapor deposition, melt extrusion, solvent deposition and high energy buffing. These techniques have disadvantages in requiring highly specialized equipment or involving the evaporation of volatile organic solvents (VOC's) that may be a source of pollution. Alternatively, these techniques may require the input of large amounts of energy. Further, many of these techniques can change the morphology of the material to be coated in an unsatisfactory manner.

However, with the advent of more sustainable use of the world's resources, a need for coated materials having nonuniform, controlled surface property profiles have been identified. Additionally, elimination of volatile solvents is driving a need for greener coating technologies.

### SUMMARY OF THE INVENTION

A method of coating a substrate with a dry composition comprising particles is provided that results in a coated substrate having a defined nonuniform surface property profile.

In a first embodiment, a patterned coating method is described which applies dry particulate coating composition onto a substrate to create a coated substrate. The method comprises the steps of positioning a substrate on a textured template having a surface contour, dispensing the particulate coating composition onto a surface of the substrate or on to an applicator pad attached to an orbital applicator head, buffing an effective amount of said particulate coating composition onto the surface of the substrate with the orbital applicator head moving in a plane parallel to surface in a plurality of directions relative to a point on the surface in an orbital manner, and varying at least one process variable of said method along the at least primary dimension of the coated film to create the nonuniform surface property profile, wherein the at least one process variable is selected from application time, application pressure, coating temperature, the contour of the work surface, orbital speed, length of an orbital path, web speed, and the particulate coating composition.

In a second embodiment, a method of coating a substrate with a dry particulate coating composition is described. The method creates a coated substrate having a controlled, nonuniform surface property profile along at least one of primary dimension of the coated substrate, wherein the primary dimension is one of a length and/or a width of the substrate. The method comprises the steps of positioning the substrate on a textured template having a surface contour, dispensing the particulate coating composition onto a surface of the substrate or on to an applicator pad attached to an orbital applicator head, vibrating the textured template during the coating of the particulate coating composition, and buffing an effective amount of said particulate coating composition onto a surface of the substrate with the at least one orbital applicator moving in a plane parallel to surface in a plurality of directions relative to a point on the surface in an orbital manner.

In a third embodiment, a method of coating a substrate with a dry particulate coating composition is described. The method comprises the steps of positioning the substrate on a textured template having a surface contour, dispensing the particulate coating composition onto a surface of the substrate or on to an applicator pad attached to an orbital applicator head, vibrating the textured template during the coating of the particulate coating composition, and buffing an effective amount of said particulate coating composition onto a surface of the substrate with the at least one orbital applicator moving in a plane parallel to surface in a plurality of directions relative to a point on the surface in an orbital manner. In some aspects of this embodiment, the method can further comprise varying at least one process variable of said method along at least primary dimension of the substrate to create a nonuniform surface property profile, wherein the at least one process variable is selected from application time, application pressure, coating temperature, the contour of the work surface, orbital speed, length of an orbital path, web speed, and the particulate coating composition.

In this Application:

“Uniform” means having a relatively consistent surface property of coating over the surface of the coated film.

“Nonuniform” means having a surface property that varies in a prescribed way across the surface of the coated film.

“Dry” means substantially free of liquid. Thus, composition of the coating material of the present invention is provided in a solid form, rather than in a liquid or paste form.

“Binder free particulate coating composition” means that the coating material comprise greater that 95% particulate solids.

“Grayscale coating” refers to a graduated coating where a property of interest can vary from a maximum value (black) down to a minimum value (white) with any value in between (shades of gray). For example, in the case of an electrothermal coating of the present invention, the region of maximum conductivity (Minimum resistivity) may be considered on the black end of the grayscale, regions of minimum or no conductivity (maximum resistivity) may be considered on the white end of the grayscale, and regions with a conductivity (or resistivity) between these extremes may be considered gray portions of the grayscale.

“Digital coating” refers to a coating where a property of interest is either present or absent (i.e. either conductive or not conductive). Thus, current would flow only through the conductive areas.

The above summary of the present invention is not intended to describe each illustrated embodiment or every implementation of the present invention. The figures and the detailed description that follows more particularly exemplify these embodiments.

### BRIEF DESCRIPTION OF THE DRAWINGS

The present invention will be further described with reference to the accompanying drawings, wherein:

FIG. 1 is a schematic diagram of an exemplary coating system according to an aspect of the present invention.

FIG. 2A is a schematic cross section of an exemplary textured template that can be employed by the coating system of FIG. 1 and FIG. 2B is a schematic cross section showing the profile of a coated substrate created using the textured template of FIG. 2A.

FIGS. 3A-3C illustrate the effect of vibrating the textured template of FIG. 2A using an exemplary coating method of the present invention.

FIG. 4 is a schematic diagram of an alternative coating section for an exemplary coating system according to an aspect of present invention.

FIGS. 5A-5C show a schematic top view of an exemplary of electrothermal film heater according to the present invention, a greyscale thermal output map and a thermal output contour map.

FIGS. 6A-6C show a schematic top view of an exemplary electrothermal film heater formed from a digitally coated substrate according to the present invention, a thermal output map and a thermal output contour map for said electrothermal film heater.

FIGS. 7A-7B show a greyscale thermal output map and a thermal output contour map for another exemplary of electrothermal film heater according to the present invention.

FIGS. 8A-8D are photographic images showing changes in hydrophobicity of a digitally coated substrate according to the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF THE EMBODIMENTS

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “forward,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized, and structural or logical changes may be made without departing from the scope of the present invention. The following detailed description, therefore, is not to be taken in a limiting sense, and the scope of the present invention is defined by the appended claims.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

Sustainability seeks to avoid the depletion of natural resources in order to maintain an ecological balance. Sustainability can also include the elimination of unnecessary solvents from manufacturing processes such as solvent based coating processes. While some solvent free coating processes exist including vacuum deposition and sputtering processes, hot melt coating and buff coating, each method may have limitations.

The present application describes improvements to a conventional buff coating process that enable 1) application of thicker coating layers, 2) application of patterned coating layers, and/or 3) deposition of coating layer(s) to produce a coated film having a nonuniform surface property profile. In particular, the exemplary method of the present invention can be used to create a coated article having an engineered coated surface with a controlled surface property profile wherein a surface property varies along at least one of the length and/or the width of the coated substrate. Surface properties that can be manipulated by the present method include surface resistivity, surface conductivity, hydrophilicity of the surface, surface energy, etc. The resulting coated films may be used in applications such as anti-fog films, dew collectors, microwave heaters, electrothermal heaters (as described in copending PCT Application No. PCT/CN2019/096289 entitled “Thin Electrothermal Film Heater With Variable Thermal Output” (Attorney Docket No. 81677WO003, filed on even date herewith), fluidic devices, heat extractors, signage, etc.

In particular, the exemplary method provides is a dry/solventless buffing coating process that does not require binders or other chemical additives to create coated articles having the desired surface property profiles of gradients. The surface property can be easily tailored by varying the desired surface property along either the length and/or the width of the coated substrate. Elimination of the solvent, binders and other additives can reduce the manufacturing cost of the exemplary articles as well as improving the properties of the articles produced.

The desired surface property profile of the coated film can be generated by controlling the coating process variables such as coating time, pressure, coating composition or patterning of the coating. For example, a linear variation in the desired surface property along the length of the coated film can be tuned by changing the coating time. Unlike conventional coating processes, like gravure printing roll coating and the like which typically yield coated films with uniform properties, the exemplary coating process described herein can create a coated film with a tailored surface property profile.

The exemplary coating process can be a continuous coating process, a stepped coating process where a region of the substrate is coated with the desired coating parameters, the substrate advanced and the next region coated or a batch coating process where the entire substrate is coated independently before being reset with a fresh section of substrate material. In some embodiments of the present invention, the coating parameters may be altered between adjacent regions in the stepwise coating process or the batch coating process.

The exemplary coating process is capable of coating a continuous flexible substrate material having a thickness up to about 200 microns, preferably between about 10 microns and 50 microns. The substrate material may be relatively smooth in nature, or alternatively may be provided with macro or micro geometry. The exemplary substrate material can be a polymer film, a nonwoven or woven web, a fibrous material such as paper, a metallic foil or a combination thereof. Exemplary polymer film substrate materials can include polyester (PET) films, polyurethane films, vinyl films, polyimide films, and polyolefin films such as linear low-density polyethylene (LLDPE) films, low-density polyethylene (LDPE) films, medium-density polyethylene (MDPE) films, high-density polyethylene (HDPE) films, and polypropylene (PP) films. In some aspects of the invention, soft metal foils may be coated with the exemplary coating process, for example, aluminum or copper foils.

The exemplary coating system can create very thin patterned coatings on a substrate from a substantially dry, binder-free particulate coating material by a buff coating process. The buff coating process is done at a temperature below the softening temperature of the substrate. The exemplary buff coating process applies binder-free particulate coating material onto a substrate wherein the particulate coating material comprise particles having a Mohs' hardness between 0.4 and 3 and size of 100 μm as the largest dimension. The particulate coating material is applied with an applicator pad at a pressure normal to the surface of greater than 0 and less than about 30 g/cm², wherein the applicator pad moves in a plane parallel to said surface in a plurality of directions relative to a point on the surface in an orbital fashion parallel to the surface of the substrate.

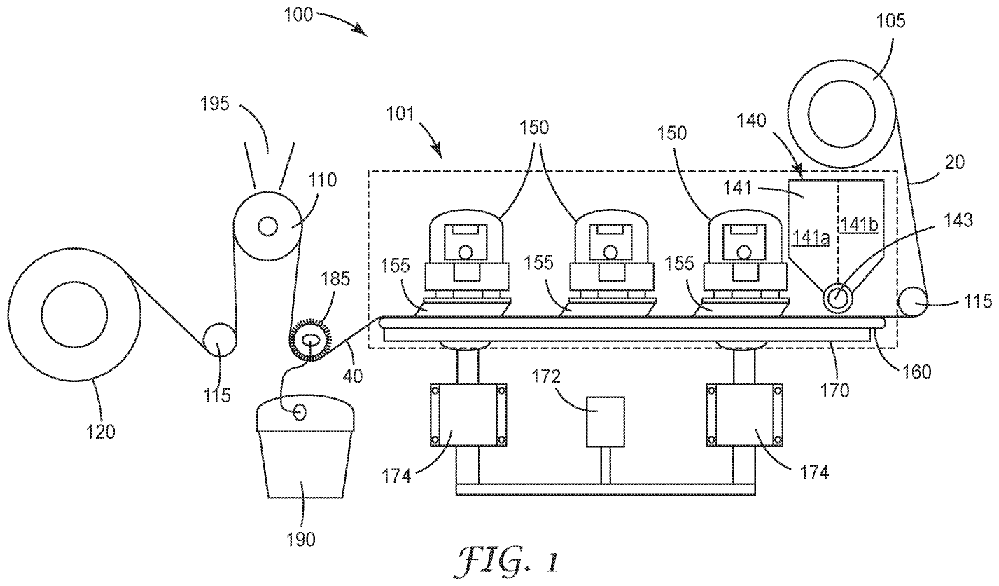

Referring FIG. 1, an exemplary coating system 100 includes continuous web handling section and a coating section. The continuous web handling section includes substrate feed roll station 105 such as a clutched off-wind station for a roll of the substrate material 20 to be coated, a web pacer drive station 110 and a winding station 120 to collect the coated substrate material 40 as well as various directing and idler rolls 115. The web handling section provides the substrate material to be coated, controls the movement of the web through the coating section, and winds the coated material onto a take-off roll.

The coating section 101 includes a powder feed station 140 to introduce the binder free particulate coating material onto the substrate 20, a coating station comprising at least one orbital applicator 150 disposed above the substrate material, a drive mechanism for controlling the movement of the at least one orbital applicator, and a textured template 160 disposed under the substrate and between the substrate and pressure plate 170.

Powder feed station 140 includes at least one supply reservoir 141 to hold the binder free particulate coating material prior to being dispensed onto the substrate. A dispensing tube can be attached to at least one supply reservoir to deliver the particulate coating material onto the substrate. A helical brush (not shown) can be mounted inside the dispensing tube to mix and meter the particulate coating material. The brush is coupled to a geared motor drive (not shown) which can control the amount of particulate coating material dispensed onto the substrate. In some embodiments, the particulate coating material composition can be premixed before it is placed into at least one supply reservoir. In other embodiments the particulate coating material can be mixed during the dispensing of the particulate coating material. In yet another embodiment, conventional dry powder feeding systems may be employed to dispense the particulate coating material in the exemplary process.

The feed station can provide precise control of the delivery rate of particulate coating material to the substrate. The feed station can further include timers controlling the rate and duration of rotation helical brush. The dispensing tube can include at least one orifice or set of orifices 143 situated above substrate 20 to distribute the powder in desired concentration across the width of the substrate. A mesh screen may be included between the tubes to aid in controlling powder dispensing or alternatively powder may be dispensed though the mesh alone.

In some embodiments, supply reservoir 141 can be divided into a plurality of subsections (e.g. subsections 141a, 141b shown in FIG. 1) which can hold the individual components of the binder free particulate coating material which can be individually metered to provide on the fly composition control for the binder free particulate coating material. In an alternative aspect, the exemplary powder feed station can include a plurality of supply reservoirs to hold the individual components. In either of these aspects an optional premixing chamber can be provided between the supply reservoir(s) and the dispensing tube. The helical brush in the dispensing tube provides the final mixing of the components of the particulate coating material.

Each orbital applicator 150 is equipped with an applicator pad(s) 155 to apply the binder-free particulate coating material to the surface of the substrate. For example, applicator pads may be woven or non-woven fabric or cellulosic material. Alternatively, the pads may be a closed cell or open cell foam material. In yet another alternative, the pads may be brushes or an array of bristles. Typically, the bristles of such brushes have lengths of about 0.2-1.0 cm, and diameters of about 30-100 microns. Bristles are preferably made from nylon or polyurethane. Preferred buffing applicators include foam pads, EZ PAINTR pads (described in U.S. Pat. No. 3,369,268), lamb's wool pads, 3M PERFECT IT pads, and the like.

Each orbital applicator 150 moves in an orbital pattern parallel to the surface of the substrate with its rotational axis perpendicular to the plane of the substrate. The buffing motion can be a simple orbital motion or a random orbital motion, such that the applicator pad(s) moves in a plurality of directions during the buffing application, including directions transverse to the direction of the web as well as longitudinal to the web. The typical orbital motion used is in the range of 500-10,000 orbits per minute.

In an exemplary aspect of FIG. 1, the three orbital applicators are shown. The orbital applicators 150 can be air-powered orbital sanding devices, such as Black and Decker model 5710 and are from Ingersol-Rand, Model 312 with a free speed of 8000 operations per minute at 90 psi air pressure, that have been modified to accept applicator pads 155 of specific configuration and materials.

The three orbital applicators can be fed from a common air line (not shown) connected to an adjustable 0 to 100 psi air regulator (not shown) allowing the adjustment of the buffing speed. For example, reducing the air pressure and increasing application pressure, orbital speeds of 0 to 4000 orbits per minute are achievable.

Below the substrate is disposed a and textured template 160 supported by pressure plate 170 that apply a buffing pressure to the substrate during coating. A precision air pressure regulator 172 supplies air (0 to 50 psi) to an air cylinder 174 to the bottom of the pressure plate to drive it upwards. By using this air pressure system, the coating pressure can be precisely controlled reducing the overall pressure necessary that is applied to the substrate to achieve the desired results. Excessive pressure can damage the substrate surface, especially when coating very thin substrates (e.g. substrates under 30 microns thick). Possible over pressure defects can include scratches, rips, tears and melting or warping of the substrate due to heating effects of friction.

Textured template 160 can have a textured surface having a three-dimensional surface structure comprising a plurality of relief features comprising elevated areas such as an elevated plateau, ridges and the like and a plurality of depressions. The texture/design on the textured surface can be transferred into the coated layer, with the elevated portions of the baseplate having a higher concentration (thickness) of coating material due to high localized application pressures than the recesses/depressions producing a patterned coated layer. The pattern of the coated layer can be controlled through proper selection of the design of the textured surface.

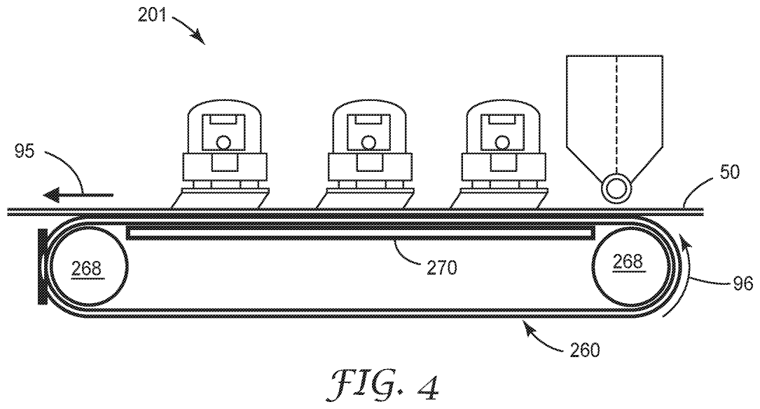

Textured template 160 can be a textured base plate 160 as shown in FIG. 1 or a textured belt 260 as shown in FIG. 4, which will be described in additional detail below.

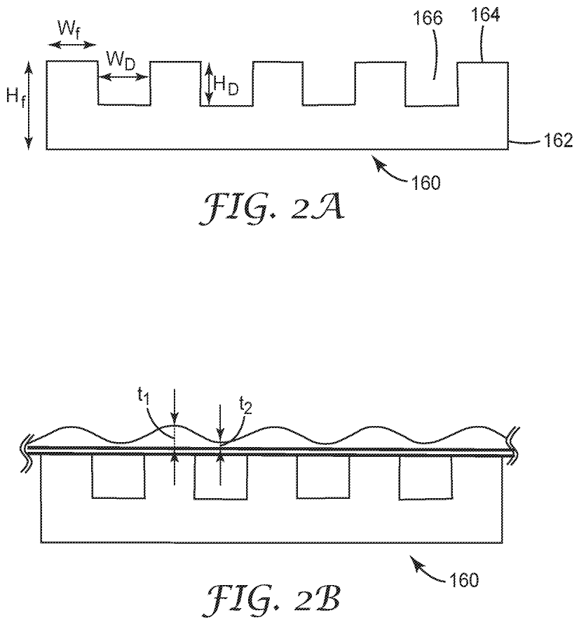

FIG. 2A shows an exemplary cross section of textured base plate 160 usable in an exemplary coating system shown in FIG. 1. The textured base plate has a pattern of raised ribs or ridges 164 extending from base plate 162. Depressions 166 are disposed between adjacent ridges. The depressions may be periodic depressions (such a divots or holes of a desired size and shape) or continuous depressions such as continuous channels or grooves. In some embodiments, the textured surface of the textured template may change along the length or width or length of the textured template. The change in the textured surface can be a change in the density, size, shape and/or height of the relief features. Changes in the relief feature can produce changes or variations in the surface properties of the coated layer.

Textured base plate 160 can locally increase the coating application pressure on top of the ridges and reduce the application pressure in the areas over the depressions which can assist in powder flow resulting an enhancement in the resulting surface properties of the coated film.

Textured base plate 160 can be characterized by the height of the elevated features, H_{f}; the width of the top of the elevated features, W_{f}; and the distance between adjacent elevated features or the width of the depression, W_{D}; and the depth of the depressions is given by HD. In the exemplary aspect shown in FIG. 2A, the elevated features are a one-dimensional array of generally rectangular beams that extend into the page. In alternative aspects, the elevated features can have a generally trapezoidal cross section, a triangular cross section or other cross-sectional shape. In another aspect, the elevated features can be arranged in a two-dimensional array or grid. In another embodiment, the elevated features or the raised areas can be distributed in a random pattern, the distance between raised area may be not constant, and the width of the elevated may not be constant either. In another embodiment, the two-dimensional shape of the elevated features may be irregular.

When the textured base plate is disposed such that the elevated features extend longitudinally in the direction that the substrate travels and is held stationary, the coated layer 50 of the coated substrate 40 will have a pattern of variable thickness that corresponds to the base plate as shown in FIG. 2A. The thickness of the coating corresponding to an elevated feature will have a thickness of t₁, while the thickness of the coated layer corresponding to a depression in the textured base plate will be thickness t₂ where t₁>t₂. In some embodiments, thickness t₁ can be as much as ten times greater than thickness t₂. In an alternative aspect, the textured base plate may be disposed such that the elevated features extend transverse at an angle relative to the direction that the substrate travels. In yet another aspect, the pattern on the textured baseplate can vary in two dimensions.

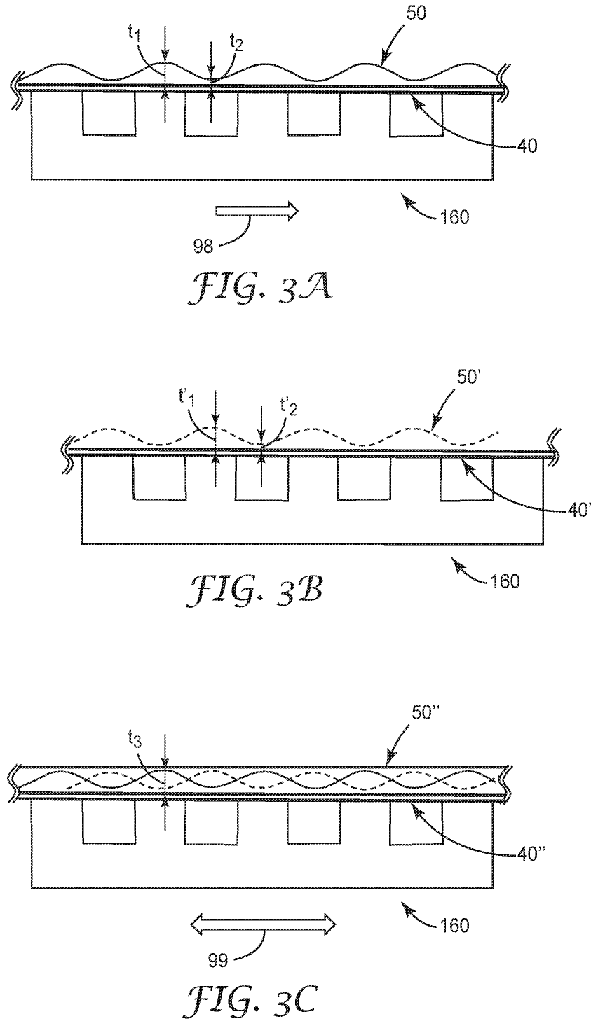

In some embodiments, the texture template can be vibrated during the coating process which can produce a more uniform, thicker coated layer that either having a stationary textured template or a flat template as illustrated in FIGS. 3A-3C. Schematic A shows the coated layer 50 of coated substrate 40 that is produced when textured base plate 160 is disposed in a first position. Schematic B shows the coated layer 50′ of coated substrate 40′ that is produced when textured base plate 160 is laterally displaced to a second position as indicated by directional arrow 98. In each case the thickness of the coating layer corresponding to the elevated features and depressions are the same (i.e. t₁=t₁′ and t₂=t₂′). Schematic C shows the coated layer 50″ of coated substrate 40″ that is produced when textured base plate 160 vibrated laterally (indicated by directional arrow 99) between the first position shown in Schematic A and a second position illustrated in Schematic B. The resulting coated layer has a more even, thicker coating thickness t₃ due to the additive and averaging effects of vibrating the textured base plate. The evenness of the resulting coating with vibration is a function of the orbit size of the buffing and the geometrical dimensions of the pattern in the template. The most even coating can be obtained when the spacing (W_{f} and W_{D}) are much smaller than the orbit diameter of the buffing process.

In an alternative aspect it may be desirable to vibrate the substrate rather than the textured template.

In some embodiments, either the textured template 160 and or pressure plate 170 may be heated.

The exemplary coating system can also include a post-coating cleaning section that can include a post-coating wiping apparatus 185 to clean excess materials on the buffed web surface, and optional vacuum collection system 190 and/or an air knife 195 for final cleaning before winding the coated substrate on the take-off roll. The post-coating wiping apparatus comprises a textured roller that wipes any excess particulate coating material from the web. In an exemplary aspect, the textured roller can be perforated and attached to a vacuum collection system 190 to collect any excess particulate coating materials, which may then be recycled if appropriate. An air knife 195 may also be used to ensure that all on the unused coating material has been removed from the surface of the coated substrate 40.

The exemplary coating system may also include a thermal device (not shown) to improve fusing of materials buffed to the web and/or a vacuum cleaning station or stations to remove any excess coating material left on the coating or the substrate. An adhesive lamination or coating station, and/or slitting station may also be incorporated into the coating system depending on the final product configuration. Alternatively, slitting, coating and laminating of additional layers onto the coated substrate can be done in an off-line process.

The exemplary coating system can create very thin coatings on a substrate from a substantially dry, binder-free particulate coating material may be obtained by a buff coating process on the substrate. The buff coating process can be carried out at a temperature below the softening temperature of the substrate. The exemplary buff coating applies binder-free particulate coating material onto a substrate wherein the particulate coating material comprise particles having a Mohs' hardness between 0.4 and 3 and size of 100 μm as the largest dimension. The particulate coating material is applied with an applicator pad at a pressure normal to the surface of greater than 0 and less than about 30 g/cm², wherein the applicator pad moves in a plane parallel to said surface in a plurality of directions relative to a point on the surface in an orbital fashion parallel to the surface of the substrate.

The active particles to be coated on the substrates include graphite, carbon black, polytetrafluoroethylene (PTFE, such as is available under the tradename TEFLON owned by The Chemours Company (Wilmington, Del.)), polyvinylidene difluoride (PVDF, such as is available under the tradename KYNAR owned by Arkema, Inc. (Prussia, Pa.)), sulfur, tungsten disulfide, polyetherimide resin (PEI, such as is available under the tradename ULTEM owned by SABIC Global Technologies B.V. (Houston, Tex.), zeolites (particularly silver zeolites), 1-ascorbic acid (vitamin C), silver chloride (AgCl), inorganic disulfides, such as molybdenum disulfide (MoS₂) and tungsten disulfide (WS₂), clays, boron nitride, silver sulfadiazine, and various amino acids.

In a particularly preferred embodiment, active coating particles are combined with a particulate buffing aid. These buffing aid particles can have a dimensional aspect ratio of about 1 and be generally spherical in shape. The buffing aid particles can have an average largest dimension of between about 0.1-10 microns. Preferably the average largest dimension is between about 0.5-2 microns. More preferably, the buffing aid particles have an average largest dimension that is the same order of magnitude as the average largest dimension of the graphite particles. The use of buffing aid particles allows for the compositional variability of the active particles as well as improving the appearance and uniformity of the coating.

Exemplary, buffing aid particles include magnetic toner particles, copper phthalocyanine, permanent red pigment available from Magruder Color Company Inc., (Elizabeth, N.J.), rose bengal stain, furnace black carbon particles, azure B dye, methyl orange dye, Eosin Y dye, new fuchsine dye, and ceramic particles such as Zeeosphere particles from 3M Zeelan Industries, MN. Preferably, magnetic toner particles may also be used as the buffing aid particles. These particles are particularly advantageous, because excess particles can be easily removed from the work area with a magnet.

The particulate coating composition can comprise from about 2 wt. % to 100 wt. % active particles and 0 wt. % to 98 wt. % of a buffing aid particles, preferably between 15 wt. % to 85 wt. % active particles and 85 wt. % to 15 wt. % of a buffing aid particles. In some aspects of the invention the particulate coating composition consists of only active particles and buffing aide particles.

In an exemplary embodiment, the particulate coating composition can comprise a 1:1 ratio of active to buffing aid particles. In an alternative aspect, the particulate coating composition can comprise a 2:1 ratio of active particles to buffing aid particles, while in another alternative aspect, the particulate coating composition can comprise a 5:1 ratio of active particles to buffing aid particles.

Mixtures of the active particles and the buffing aid particles can be coated onto the surface of substrate to form a coated substrate having a desired surface property profiles or gradient. The surface property can be easily tailored by varying the desired surface property along either the length and/or the width of the coated substrate. For example, in a first aspect, an active graphite particle can be used with a Magenta buffing aid particle to create a substrate having a sheet resistance gradient the changes in at least one of the length and or width of the substrate. The resulting graphite coated film can be used to create an electrothermal film heater with a variable thermal output.

The adhesion of the coating to the substrate may improve substantially a few days after coating. For example, the combination of graphite coating on a polyester substrate provides excellent adhesion after only about one day, with no heating required. Alternatively, the coated substrate may be heat treated to improve the adhesion of the coating layer to the substrate. The heat treatment is carried out at a temperature below the temperature at which the substrate will distort. Typically, this temperature is between about 10° C. below the softening temperature of the polymer substrate up to the softening temperature of the polymer substrate.

The thickness of the buffed coating can be controlled by varying any of a selected set of coating variables, such as coating composition, coating feed rate, buffing time, buffing speed, buffing pressure, etc. Changing one of these coating processes in either a cross web or down web direction will create a nonuniform coating which can yield a coated article having and engineered surface with controlled variable surface properties such as surface resistance, resistivity, conductivity or hydrophilicity depending on the coating material used.

For example, the thickness of the coating increases linearly with time after a certain rapid initial increase. The longer the buffing operation, the thicker the coating. Thus, changing the line speed during the coating process allows the formation of a coating layer that has a controlled nonuniform thickness profile along the length of the substrate. Alternatively, the thickness of the coating can be controlled by controlling the amount of particulate coating material on the applicator pads used for buffing.

FIG. 4 is a schematic diagram of a modified coating section 201 for the exemplary coating method of the present invention. In this embodiment, the textured base plate 160 (FIG. 1) is replaced by a textured belt 260 and drive train represented by drive rollers 268 in FIG. 4. The textured belt runs over the pressure plate and supports substrate 50 during the coating process. In one aspect, the use of the textured belt can be especially useful when coating very thin substrates (<30 microns thick) which otherwise could not be guided through the process without damaging the substrate 50. When thin substrates are being coated, the line speed (indicated by arrow 95) should be the same as the belt speed (indicated by arrow 96).

In some embodiments, the substrate to be coated, particulate coating composition used to form the pattern after coating and coating conditions (e.g. the friction between the substrate and the coating composition) will determine how sharp the definition of the resulting pattern is on the coated substrate.

In another embodiment of the present invention, a method of coating a substrate with a dry, binder-free particulate coating composition to create creating a coated substrate having a controlled, nonuniform surface property profile is disclosed. The nonuniform surface property profile will vary along at least one primary dimension (i.e. along the length or width) of the coated substrate. The substrate is positioned on a textured template that has a defined surface contour. The particulate coating composition is applied to one of a substrate surface or an applicator pad on at least one orbital applicator. An effective amount of the particulate coating composition is buffed onto a surface of the substrate with the at least one orbital applicator moving in a plane parallel to surface in a plurality of directions relative to a point on the surface in an orbital manner. Varying at least one process variable during coating enables creation of the nonuniform surface property profile. In an exemplary aspect, the process variable is altered along the at least primary dimension of the coated film to create the nonuniform surface property profile, wherein the at least one process variable be selected from application time, application pressure, coating temperature, the contour of the work surface, orbital speed, web speed, and the dry binder free coating powder composition.

In some embodiments, the exemplary coating system can comprise a plurality of orbital applicator arranged in a two-dimensional array along the width and length of the substrate, wherein the orbital arrays are disposed in rows. Each orbital applicator or each row of orbital applicators can be independently controlled. In an exemplary aspect, each row of orbital applicators disposed in the width direction (into the page in FIGS. 1 and 4) can be controlled independently from each row of orbital applicators disposed adjacent in adjacent rows. For example, at least one process variable can vary between adjacent rows of orbital applicators to create a coated substrate with a nonuniform surface property profile along the width of the substrate, wherein the at least one process variable be selected from application time, application pressure, coating temperature, orbital speed, web speed, and the dry binder free coating powder composition.

In an alternative aspect, the textured template can be varied transverse to the length of the substrate (i.e. the width direction). The density, size, pattern, and shape of the elevated features can be varied along the width of the textured template.

In another embodiment of the present invention a method of coating a substrate with a dry, binder-free particulate coating composition to create creating a coated substrate having a controlled, nonuniform surface property profile is disclosed. The nonuniform surface property profile will vary along at least one primary dimension (i.e. along the length or width) of the coated substrate. The substrate is positioned on a textured template that has a defined surface contour. The particulate coating composition is applied to one of a substrate surface or an applicator pad on at least one orbital applicator while vibrating the textured template. An effective amount of the particulate coating composition is buffed onto a surface of the substrate with the at least one orbital applicator moving in a plane parallel to surface in a plurality of directions relative to a point on the surface in an orbital manner. At least one process variable can be varied during coating enables creation of the nonuniform surface property profile. In an exemplary aspect, the process variable is altered along the at least primary dimension of the coated film to create the nonuniform surface property profile, wherein the at least one process variable be selected from application time, application pressure, coating temperature, the contour of the work surface, orbital speed, web speed, and the dry binder free coating powder composition.

The present continuous web process can be capable of producing coated substrates with unique characteristics that offer substantial utility to many markets. The process involves application of particulate coating materials to a substrate with a lateral “buffing” action. Coatings thus produced may have various electrical, optical and decorative features.

### EXAMPLES

### Example Materials

| Abbreviation | Description and Source |
|---|---|
| KS6 | TIMREX KS6 Primary Synthetic Graphite available |
| | from Imerys Graphite & Carbon (Switzerland) |
| Magenta | Microsphere Magenta Pigment (MP-MG5518) available |
| | from Dayglo Color Corporation (Cleveland, Ohio) |
| PTFE | 3M ™ Dyneon ™ PTFE TF 9201Z available from 3M |
| powder | Dyneon (Neuss, Germany) |
| PET film | HOSTAPHAN 224ON Polyester film (0.56 mil gauge |
| | (14 micron)) available from Mitsubishi |
| | Polyester Film, Inc. (Greer, SC) |
| Perforated | 3M SCOTCHCAL Perforated Window Graphic |
| Vinyl film | Film 8170:P50 available from 3M Company |
| | (London, Ontario) |
| Bus bars | 0.25 inch wide 3M ™ EMI Copper Foil Shielding |
| | Tape 1181 available from 3M Company |
| | (St. Paul, MN) |

### Test Methods

### Sheet Resistance Method 1

Sheet resistance of the samples was measured using a handheld 4-point probe measurement device (RChek 4 Point Meter Model RC2175 from Electronic Design to Market, Inc. (Toledo, Ohio)) at 5 locations around the sample area. The measured sheet resistance values were averaged and reported sheet resistance for the sample.

### Sheet Resistance Method 2

For duplication, a non-contact sheet resistance was also measured a 737 conductance monitor from DELCOM Instruments (Minneapolis, Minn.) in the same areas to ensure repeatable and reliable results.

### Determining Heat Output and Temperature Profile

Samples were energized at the desired wattage while attached to insulator material, e.g. LEXAN polycarbonate plates (Lexan® is a trademark owned by SABIC GLOBAL TECHNOLOGIES B.V. (Noord-Brabant, Netherlands)) or a 1″ thick insulating foam (FOAMULAR obtained from Home Depot, London ON). The LEXAN plate was 5 mm thick, and 1 sq. ft. in area. The samples were taped to the substrate with the conductive coating facing up. While taped to the Lexan plate, leads for the power source were connected to the bus bars before energizing.

To energize the electrothermal films to generate heat, samples were connected to a low voltage power (Under 30V) source (model; PSA2530D, Circuit Test Electronics (Vancouver, British Columbia, Canada)) which inherently monitors both the voltage and current being applied to the sample. These values were used to calculate the wattage of the sample, along with the area, to determine the heat output of the film. Wattage is defined as the product of voltage and current.

To determine the temperature and distribution of heat along an energized sample, an IR camera (Model E8 from FLIR Systems (Burlington, Ontario, Canada)) was used. Samples were left energized until the temperature reached a maximum. No insulating layer was placed over top so the electrothermal films were exposed to ambient lab conditions (20° C.). Once the temperature stopped rising, an IR image was taken in which the maximum, minimum and temperature profile could be extracted using FLIR Tools+ software from FLIR Systems. Once the image was taken, and the voltage and amperage values were recorded, the power source was disconnected. If a subsequent sample was to be tested, a new Lexan plate was used that was at room temperature since the temperature of the Lexan plate was noticeably increased after each test.

### EXAMPLES

### Example 1: Patterned Graphite Coating

An exemplary buff coating system is equipped with a textured base plate having a one-dimensional array of generally rectangular beams extending from a base plate. The height of the ridges, HR, was 0.050 inches (1.27 mm). The width of the top of the ridges, WR, was 0.050 inches (1.27 mm). The width of the depression, WD was 0.075 inches (1.90 mm).

A 14 micron thick PET film substrate was placed on top of the textured base plate. The binder-free particulate coating material comprising a 1:1 mixture of magenta pigment (MP-MG5518 grade from Dayglo Color Corp, Cleveland, Ohio) and KS6 synthetic graphite (TIMCAL TIMREX KS6) was dispensed onto the substrate. An orbital applicator (Makita Finishing Sander, model no. B04900V) equipped with an EZPaintr applicator pad saturated with the graphite coating mixture by orbiting the applicator pad in an excess of the powder coating prior contacting the substrate with a pressure of 0.2 psi. The orbital applicator was turned on with the orbital motion set to a rate of 900 orbits per minute. The buffing time was 60 seconds which yielded a graphite coating having a thickness 0.4 microns.

Once the determined coat time had passed, the coating head was stopped and raised from the substrate surface. The film was then cleaned of residual powder by blowing ionized air across the surface. The film was then removed from the supporting glass plate and set aside for characterization.

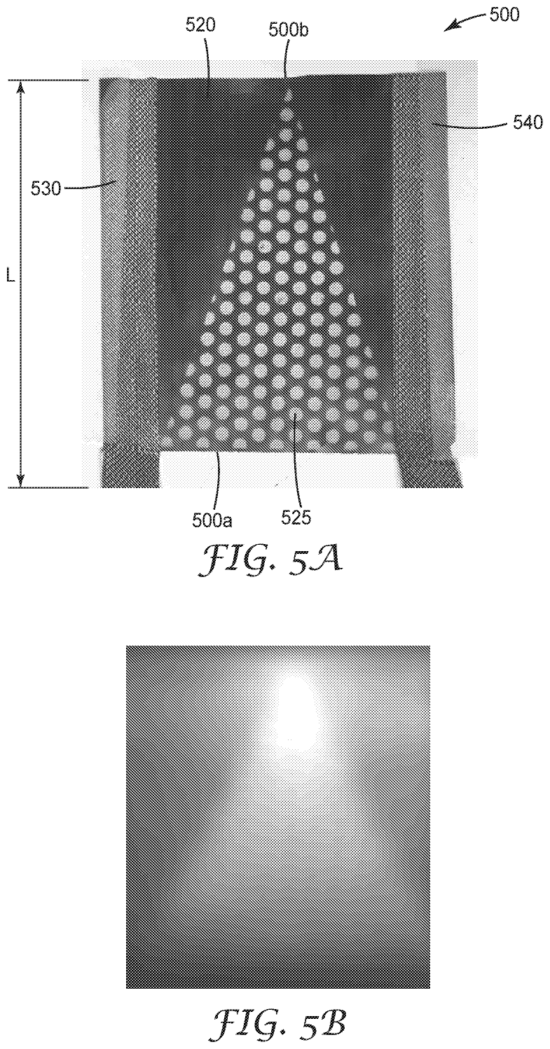

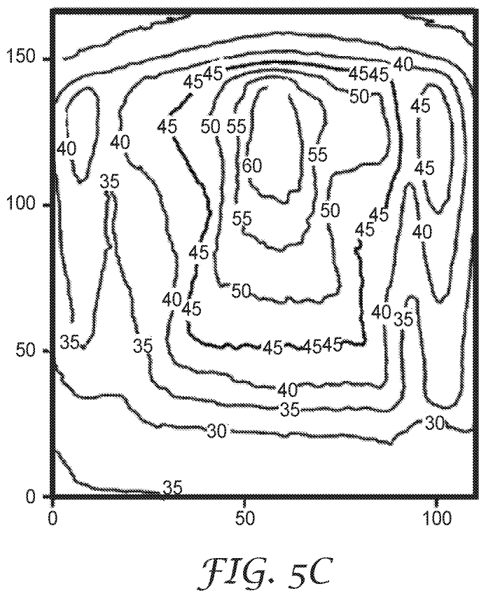

A triangular piece of perforated vinyl film (SCOTCHCAL 8170 Perforated Window Graphic Film from 3M, St. Paul. Minn.) was placed on top of the graphite coated film to serve as a mask. The perforated vinyl film had a 50% density of circular openings. A SPEED BLASTER Portable Media Blaster (model:007) obtained from McMaster-Carr, Illinois, USA, was used to remove the exposed graphite coating with sodium bicarbonate particles at a 30 psi air pressure. After a 6 second blast, the template was removed, and a very regular dot pattern corresponding to the template was obtained as shown in FIG. 5A. The circles in the pattern in the graphite coating are of diameter around 1.5 mm.

An Electrothermal film heater EFH1 was formed from a 4 inch by 4 inch sample of the patterned coated material of example 1 described above. A strip of 0.25 inch wide 3M™ EMI Copper Foil Shielding Tape 1181 available from 3M Company (St. Paul, Minn.) was laminated to two opposing edges of the patterned coated film to create the bus bars 530, 540 of the electrothermal film heater (EFH1) 500. FIG. 5A is a photograph of electrothermal film heater (EFH1) g00 showing the pattern of circular openings 525 in the coated graphite layer 820.

The electrothermal film heater EFH1 was placed on a 1″ thick insulating foam (FOAMULAR obtained from Home Depot, London ON). A voltage of 10V was then applied to the bus bars. After waiting 5 minutes for the electrothermal film heater to reach equilibrium, a thermal image was taken with an infra-red thermal camera (Model E8 available from FLIR Systems, Burlington, Ontario, Canada) set up about 30 cm away from the sample. FIGS. 5B and 5C show the recorded thermal image in grayscale and the corresponding contour map showing variable thermal output along the length of electrothermal film heater. Note that darker colors indicate lower temperatures and lighter color indicate warmer temperature on the grayscale thermal image. Referring to FIGS. 5A and 5C, the temperature of the heater is lowest close to the first end 500a of the electrothermal where the density of circular openings is highest. The circular openings increase the resistance of the film near the first end thus lowering the amount of energy passing through the coating resulting in a lower thermal output. In contrast the highest temperature occurs near the second end 500b of electrothermal film heater EFH1 where the density of openings in the film is lowest.

Table 1 shows the temperature gradient (dT/dx) obtained along the centerline of electrothermal film heater EFH1 formed from the patterned graphite coated material of Example 1 at several applied voltages.

TABLE 1

| Applied | Wattage | dT/dx |
|---|---|---|
| Voltage (V) | (W) | (° C./mm) |
| 5 | 0.18 | 0.19 |
| 7.5 | 0.45 | 0.45 |
| 10 | 0.8 | 0.85 |

### Example 2: Digital Graphite Patterned Coating

A digitally coated film was created that had a step change in coating thickness. The digitally coated film was made by coating the entire substrate with a uniform coating as prescribed above, and then indexing the substrate by a set longitudinal distance and applying a second layer of the particulate coating material creating two zones having with different graphite coating thicknesses.

Specifically, a 10 in.×10 in. 14 micron thick PET film substrate was coated as described above with a dry particle coating composition comprised a 1:1 mixture of magenta pigment (MP-MG5518 grade from Dayglo Color Corp, Cleveland, Ohio) and KS6 synthetic graphite (TIMCAL TIMREX KS6). The buffing time was 20 seconds. The resulting coating layer had a thickness 0.2 microns. The substrate was then indexed longitudinally by about 5 inches creating a first sheet resistance zone having a coating having a thickness if 0.2 microns. A second layer was buff coated on the remaining portion for an additional 10 seconds (or for a total of 30 seconds) creating a second sheet resistance zone having a thickness of 0.3 microns.

When the digitally coated film was coated with graphite as provided here, the digitally coated film can be used to create a variable output electrothermal film heater having a sheet resistance with distinct ‘zones’ of uniform but different heat output. Electrothermal film heater (EFH2) was formed by laminating a strip of 0.25 inch wide 3M™ EMI Copper Foil Shielding Tape 1181 available from 3M Company (St. Paul, Minn.) along the two longitudinal edges of the digitally coated substrate to create the bus bars of the electrothermal film heater EFH2.

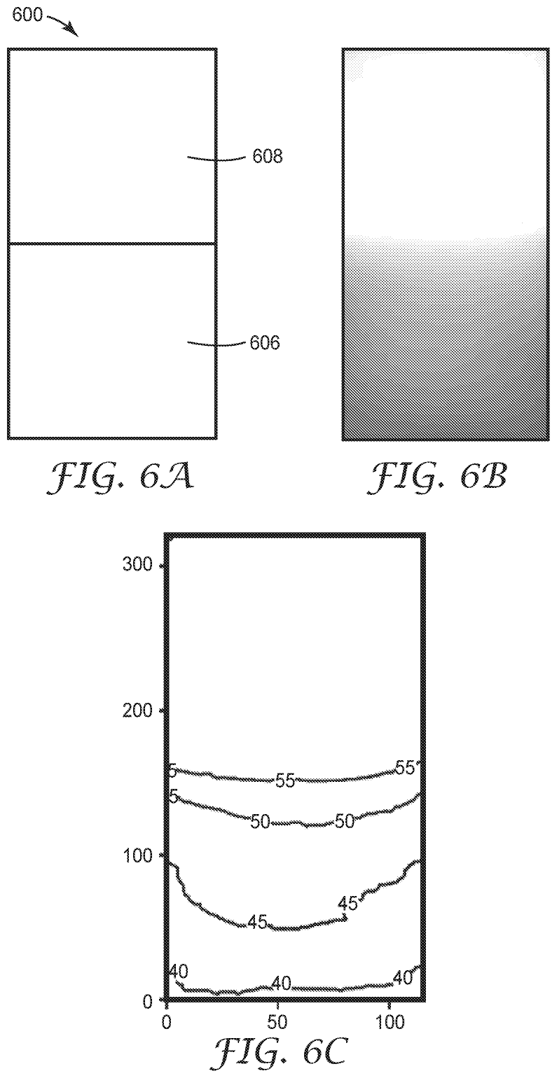

FIG. 6A is a schematic diagram electrothermal film heater EFH2 600 showing the position of the first sheet resistance zone 606 and the first sheet resistance zone 608. FIGS. 6B and 6C shows the recorded thermal image in grayscale and the corresponding contour map showing variable thermal output along the length of electrothermal film heater EFH2.

The maximum and minimum temperature and the high and low resistance values for the electrothermal film heaters EFH2 is shown in Table 2.

### Example 3: Greyscale Patterned Graphite Coated Film

A greyscale coated film was created having a continuously changing coating thickness profiles along the length of the film. The greyscale coated film was created by changing the buffing time of the particulate coating along the length of the film. The entire film started underneath the coating head, and after continuous buffing of roughly 20 seconds, the coating head was continuously advanced to simulate web movement. The web was moved over a duration of 10 more seconds, resulting in a buffing time of about 30 seconds on the second end of the film.

A greyscale coated electrothermal film heater EFH3 was created from the greyscale coated film such that the sheet resistance changed gradually along the length of the greyscale coated electrothermal film heaters. Electrothermal film heater EFH3 was formed by laminating a strip of 0.25 inch wide 3M™ EMI Copper Foil Shielding Tape 1181 available from 3M Company (St. Paul, Minn.) along the two longitudinal of the greyscale coated substrate to create the bus bars of the electrothermal film heater EFH3.

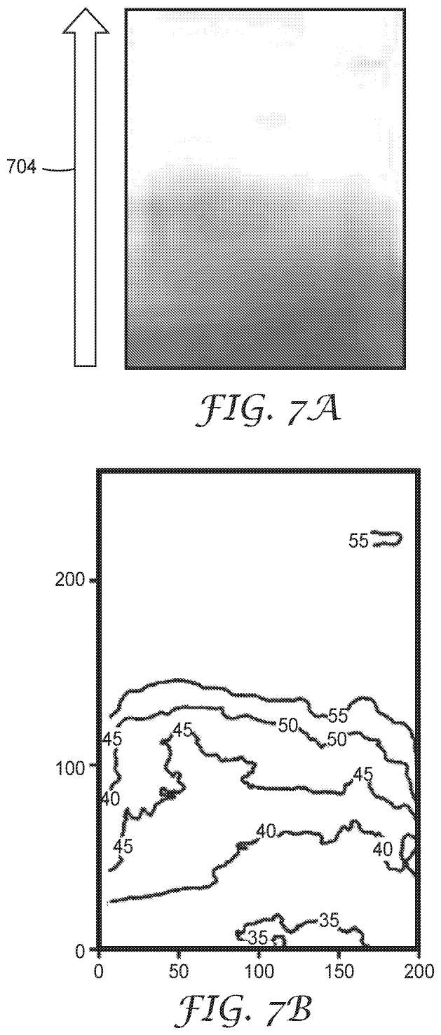

FIGS. 7A and 7B shows the recorded thermal image in grayscale and the corresponding contour map showing variable thermal output along the length of electrothermal film heater EFH3. FIG. 7A includes arrow 704 indicting the thickness gradient of the coating layer on the substrate.

The maximum and minimum temperature and the high and low resistance values for the electrothermal film heaters EFH3 is shown in Table 2.

TABLE 2

| | Greyscale | Digital |
|---|---|---|
| | Electrothermal | Electrothermal |
| | Film | Film |
| | Heater (EFH3) | Heater (EFH2) |
| High Resistance (Ohm/□) | 200 | 180 |
| Low Resistance (Ohm/□) | 90 | 90 |
| Voltage (V) | 20 | 20 |
| Max Temperature (° C.) | 55 | 55 |
| Min Temperature (° C.) | 35 | 40 |

### Example 4: Greyscale Polytetrafluoroethylene (PTFE) Patterned Coating

A greyscale PTFE coated film was prepared by a method analogous to that used in Example 3 to create a film having a variable hydrophobicity resulting from a PTFE coating concentration gradient along the length of the film. The greyscale PTFE film was created by changing the powder feed ratio under the coating head in different areas of the film.

Specifically, a first particulate coating composition comprising 100% PTFE powder was dispensed on a first end of the 8″×12″ PET film substrate and applied over about 75% of the film from the first end of the substrate film. A second particulate coating composition comprising 20 wt. % KS6 graphite and 80 wt. % PTFE was dispensed on a second end of the substrate film and applied over about 75% of the film from the second end of the substrate film on three quarters of the film on the other end.

The resulting greyscale PTFE film had a 100% PTFE coating on the first end and an 80% PTFE coating on the second end, and a variation in coating thickness in the middle portion of the substrate film and resulted in a continuous gradual change in water contact angle between the first and second ends of the film.

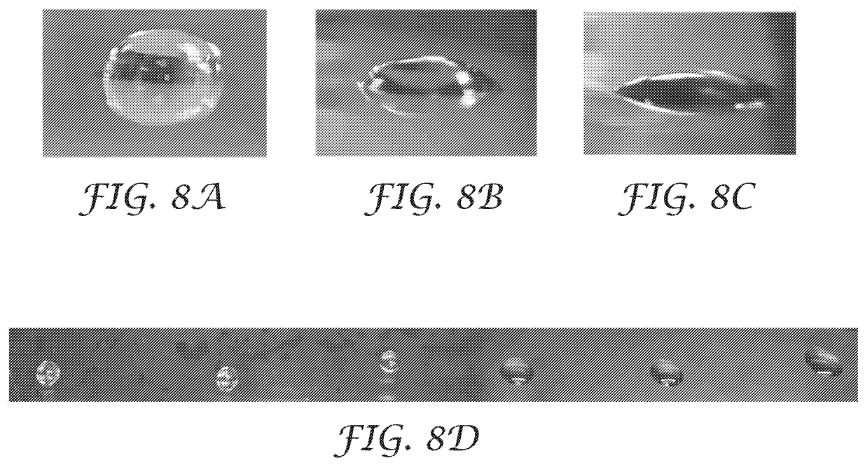

The hydrophobicity of the coated films surface was measured by applying a droplet of deionized water on the surface of the coated film and observing the contact angle. FIGS. 8A-8D show droplets of water applied to the variable hydrophobic coating from a pipette. On the first end of the coated film coated with 100% PTFE water contact angle was very high, approaching 90 degrees as shown in FIG. 8A which signifies a hydrophobic coated surface. In the middle transition portion, the droplet has a lower contact angle (FIG. 8B), while on the second end of the film (i.e. coated with the PTFE/KS6 mixture), the water droplet has a very low water contact angle (FIG. 8C), signifying a poorly hydrophobic surface. Thus, it is possible to engineer hydrophobicity of a film by changing the mix ratio of PTFE to graphite in the particulate coating composition. This approach could be utilized in a continuous operation by varying feed ratios of the components of the particulate composition to change hydrophobicity continuously along a film length in one coating operation (FIG. 8D).

### Example 5: Buff Coating Process with a Stationary Textured Base Plate (Comparative Example)

An exemplary buff coating system was equipped with a textured base plate having a one-dimensional array of generally rectangular beams extending from a base plate. The height of the ridges (or depth of the depressions between adjacent ridges), HD, was 0.050 inches (1.27 mm). The width of the top of the ridges, W_{f}, was 0.020 inches (0.51 mm). The width of the depression, W_{D} was 0.02 inches (0.51 mm). The base plate was fixed on to a horizontal metal plate attached to a Magnetic Feeder (FMC Syntron Model FTOC obtained from FMC, Mississippi USA).

A 14 micron thick PET film substrate was placed on top of the textured base plate. The binder-free particulate coating material comprising 100 wt. % KS6 synthetic graphite (TIMCAL TIMREX KS6) was dispensed onto the substrate. An orbital applicator (Makita Finishing Sander, model no. B04900V) equipped with an EZPaintr applicator pad was saturated with the graphite powder by orbiting the applicator pad in an excess of the powder coating prior contacting the substrate with a pressure of 0.2 psi. The orbital applicator was turned on with the orbital motion set to a rate of about 2000 orbits per minute. The base plate was kept stationary during coating.

Once the determined coat time of 30s had passed, the sander was stopped and raised from the substrate surface. The film was then cleaned of residual powder by blowing ionized air across the surface. The film was then removed from the supporting glass plate and set aside for characterization.

Visual inspection of the coated sample showed that the graphite was deposited in a pattern that was nearly identical to the textured base plate having alternating thick deposits in either side of very light coating deposits.

### Example 6. Buff Coating Process with a Vibrating Textured Base Plate

A new PET substrate was placed on the textured base plate and the buff coating process described in example 5 was repeated except in this example the textured base plate was vibrated during coating. The FMX Syntron plate with the textured base plate attached thereto was set to vibrate at setting 10 on its variable dial. After buff coating for 30s, the coated substrate was cleaned of excess powder with an ionized air gun and removed from the base plate for characterization.

Visual inspection showed nearly uniformly dark thick coating.

Table 3 shows the comparison of sheet resistance measured with samples in Example 5 and 6. The sheet resistance is inversely proportional to the thickness of a conductive coating. Assuming the electrical resistivity of graphite is the same in both coatings, the measurement indicates that the average thickness nearly doubled with the vibrating base plate. This is in accordance with the cross sectional diagrams in FIGS. 3A and 3C, where the average thickness would be t1/2=t3/2 with stationary base plate (3A), and t3 with a vibrating plate (3C). Thus, the thickness ratio should be close to 2.

TABLE 3

| | Sheet Resistance | Thickness |
|---|---|---|
| | (Ohm/[ ]) | Ratio |
| Example 5. (comparative) | 235 | 2.2 |
| Stationary pattern | | |
| Example 6. Vibrating | 105 | 1 |
| pattern | | |

1. A patterned coating method with a dry particulate coating composition to create a coated substrate, comprising
positioning a substrate on a textured template having a surface contour;
dispensing the particulate coating composition onto a surface of the substrate or on to an applicator pad attached to an orbital applicator head;
buffing an effective amount of said particulate coating composition onto the surface of the substrate with the orbital applicator head moving in a plane parallel to surface in a plurality of directions relative to a point on the surface in an orbital manner; and
varying at least one process variable of said method along the at least primary dimension of the coated film to create a nonuniform surface property profile, wherein the at least one process variable is selected from application time, application pressure, coating temperature, the contour of the work surface, orbital speed, length of an orbital path, web speed, and the particulate coating composition.

2-3. (canceled)

4. The method of claim 1, wherein the particulate coating composition is binder free.

5. The method of claim 1, wherein the particulate coating composition comprises active particles to provide the coated substrate with a desired surface property.

6. The method of claim 1, wherein the particulate coating composition consists essentially of active particles and buffing aid particles.

7. The method of claim 1, wherein the particulate coating composition comprises 2 wt. % to 100 wt. % graphite particles and 0 wt. % to 98 wt. % buffing aid particles.

8. The method of claim 1, wherein the particulate coating composition comprises 20 wt. % to 80 wt. % graphite particles and 80 wt. % to 20 wt. % buffing aid particles.

9. The method of claim 1, wherein the textured template is a textured plate positioned beneath the substrate during coating, wherein the surface contour of the textured template comprises elevated features and depressed features.

10. The method of claim 1, wherein the textured template is a textured belt that moves at the same velocity as the substrate being coated, wherein the surface contour of the textured template comprises elevated features and depressed features.

11. The method of claim 10, wherein coated substrate produced from using the textured template has a thickness profile resulting from the textured surface contour.

12. The method of claim 10, wherein coated substrate produced from using the textured template uniform thickness profile resulting from vibrating the textured template during coating.

13. The method of claim 1, wherein controlled, nonuniform surface property profile can be selected from a coating thickness profile, an electrical conductivity profile, a surface energy profile, ultraviolet light property profile, an electrical surface resistivity profile, and a barrier property profile.

14. The method of claim 1, wherein the particulate coating composition comprises graphite powder to produce a coated article with a nonuniform electrical surface resistivity profile.

15. A method of coating a substrate with a dry particulate coating composition, comprising:
positioning the substrate on a textured template having a surface contour;
dispensing the particulate coating composition onto a surface of the substrate or on to an applicator pad attached to an orbital applicator head;
vibrating the textured template during the coating of the particulate coating composition; and
buffing an effective amount of said particulate coating composition onto a surface of the substrate with the at least one orbital applicator moving in a plane parallel to surface in a plurality of directions relative to a point on the surface in an orbital manner.

16. The method of claim 15, wherein the particulate coating composition is binder free.

17. The method of claim 15, wherein the particulate coating composition comprises active particles to provide the coated substrate with a desired surface property.

18. The method of claim 15, wherein the particulate coating composition consists essentially of active particles and buffing aid particles.

19. (canceled)

20. The method of claim 15; further comprising:
varying at least one process variable of said method along at least one primary dimension of the substrate to create a nonuniform surface property profile, wherein the at least one process variable is selected from application time, application pressure, coating temperature, the contour of the work surface, orbital speed, length of an orbital path, web speed, and the particulate coating composition.
